(19) United States
(12) Patent Application Publication
(10) Pub. No.: US 2004/0212723 A1
(43) Pub. Date: Oct. 28, 2004

(54) Image pickup apparatus and operating method

(76) Inventor: Malcolm Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/419,900

(22) Filed: Apr. 22, 2003

(51) Int. Cl. H04N 5/235

(52) U.S. Cl. 348/362

(57) ABSTRACT

An image pickup apparatus comprises a CMOS image sensor, a lens module with mechanical shutter and a timing control means. The CMOS image sensor further has a electronic shutter mechanism that can provide exposure of the entire array at the same. The mechanical shutter is disposed between the CMOS image sensor and the lens or the lens is disposed between the mechanical shutter and the CMOS image sensor. The timing control means is coupled to the CMOS image sensor and the mechanical shutter. An operating method is provided to control the electronic shutter and mechanical shutter in order to achieve the best exposure control.

### BACKGROUND OF THE INVENTION

1. Field of the Invention

The present invention relates to an image pickup apparatus which utilizes a CMOS image sensor with an electronic shutter, and particularly relates to an image pickup apparatus and an operating method which combines the electronic shutter and a comparatively low speed mechanical shutter to achieve short and precise exposure period in performing image pickup.

2. The Related Art

Mechanical shutter has been adopted extensively in CCD-based digital still camera systems. In the early stage of development of electronic still cameras, mechanical shutter was used to completely control the exposure of the camera. For example, U.S. Pat. No. 4,910,606 describes an electronic camera with mechanical shutter to control exposure. Mechanical shutter is used in continuous mode digital camera in order to improve signal quality and reduce or eliminate smear. Electronic shutter time is fixed at 1/60 second and the actual exposure period is controlled by opening and closure of the mechanical shutter. The mechanical shutter is closed at vertical sync period and the charges are read out during this period. Very short exposure period is difficult to achieve.

Another electronic still camera is described in U.S. Pat. No. 5,767,904, which relies on mechanical shutter open and close to control the amount of exposure. The main target of this patent is to start synchronizing signal immediately after the user presses the shutter release button, so that no delay variation is present. The speed of the mechanical shutter has to be very fast and precise in order to obtain very short exposure period.

Since it is difficult to achieve precise and fast mechanical shutter for exposure control, prior arts later developed methods of combining electronic shutter with mechanical shutter in order to obtaining better exposure control. For instance, U.S. Pat. No. 5,140,426 describes an electronic camera with electronic and mechanical shutter. Relatively slow mechanical shutter is used with an FIT-CCD image sensor. The first field is quickly moved to the frame buffer so that smear is not that significant. After the second field is sent to the vertical CCD, the mechanical shutter is closed to protect the image charges corresponding to the second field from smear effect. The start of exposure is controlled by sending out unnecessary charges to vertical CCD and shifted out. The unnecessary charges in the first field are sent out first and then the unnecessary charges in the second field are sent out next. The instant of start of exposure for the second field is actually delayed appropriately in order to make the length of exposure period equal for the two fields. Consequently, the two fields are not exposed at the same instant. Further, it is difficult to achieve very short artificial electronic shutter time in this kind of design.

With the need for lower cost and higher yield in semiconductor image pickup devices, it becomes evident that interline-transfer CCD with interlaced readout is required. In order to achieve better exposure control, a different method of mechanical shutter control is developed. For example, U.S. Pat. No. 5,517,243 describes an electronic still camera with mechanical shutter control. Electronic shutter is combined with mechanical shutter so that the precision of shutter time is improved and smear is eliminated. The start of exposure is controlled by sending out unnecessary charges to vertical CCD and shifted out. The end of exposure is controlled by the closure of the mechanical shutter. After mechanical shutter is closed, the charges are sent to vertical CCD and read out. In field photography mode, the first field is sent to vertical CCD after mechanical shutter is closed and then shifted for two cycles. Next the second field is sent out to combine with the first field and effectively increasing the equivalent sensitivity by two. The charges are then read out line by line. In frame photography mode, the first field is sent to vertical CCD after mechanical shutter is closed and then read out sequentially. Next the second field is sent to the vertical CCD and read out sequentially.

With the combination of electronic shutter with mechanical shutter, even though the exposure period is controlled by the mechanical shutter, the speed requirement of the performance of the mechanical shutter is reduced. However, because of limitation in lens design, a fast enough mechanical shutter is still required in order to provide good exposure coverage. There is, therefore, a need to design an electronic still camera that relies completely on electronic shutter to control the exposure. In this way, it is possible to provide a precise and very short exposure period. For instance, U.S. Pat. No. 6,292,220 describes such a design. Electronic shutter is combined with mechanical shutter in a progressive scan interline transfer CCD. Start of exposure is controlled by overflow drain pulses, and end of exposure is controlled by transferring out charges to vertical CCD. The mechanical shutter is closed immediately after charge transfer to prevent smear during readout. Since the charges are already stored in the vertical CCD during the period that the mechanical shutter is closing, it is still possible that smear can occur. In order to reduce smear, special timings are added to shift the vertical CCD slowly during the mechanical shutter close time. This method can only be used with progressive-scan CCD, which is usually limited to pixel number less than 1,000,000. Further, smear is not completely eliminated and complex timing is needed to reduce the effect of smear, it is not used by most still camera designers.

The current art application of electronic shutter and mechanical shutter control in interline-transfer CCD with interlaced readout is illustrated in FIG. 11. For the CCD, image charge stored on the photodiode can be cleared with a SUB pulse as indicated in FIG. 11. Therefore, the start of exposure can be controlled precisely by the so-called “electronic shutter” in order to reduce the design complexity of the mechanical shutter. Consequently, the mechanical shutter only needs to control the closing of the exposure with good enough precision. The main purpose of adopting mechanical shutter in CCD-based digital still camera systems is to remove the smear phenomena during charge readout.

FIG. 11 shows typical timing sequence for such shutter control method. Because of consideration of the driving capability of the vertical CCD, it has to adopt interlaced readout in still image capture mode. In this way, the image data is divided into two fields, FIELD 1 and FIELD 2. FIELD 1 contains odd-number lines, while FIELD 2 contains even-numbered lines. The control timing relies on the vertical synchronization signal VD as references for each cycle. The cycles are designated as V1, V2, V3, etc. In the “Preview” mode, the mechanical shutter or light shielding means remain opened, and the CCD continuously sends out part of the image data for processing. This is represented as V1, V2 and V6. During the Preview mode, as only parts of the image data are collected and read out, the time spent on the vertical CCD is shorter and smear is not that important.

In the “Still Image Capture” mode, the timing is represented as V3, V4 and V5. The exposure period is designated as “EXP”. The beginning of the exposure is controlled by SUB pulses. At the end of the last pulse, the charge stored at the photodiodes of the entire image sensor will become the image charges. In order for both fields to have the same exposure amount, mechanical shutter or light shield means is closed at end of V3. After the incident light is blocked, transfer gate signal TG3 sends FIELD 1 to vertical CCD for readout. At the end of V4, transfer gate signal TG4 sends FIELD 2 to vertical CCDs for readout. After FIELD 2 is completely read out, the light shield means is opened again to allow for image capture again. Before the still image charges of FIELD 1 are transferred to the vertical CCDs, there is a high speed charge sweep process to clean out the residual charges accumulated on these vertical CCDs because of light leakage. The effect of smear can then be removed or reduced significantly.

In typical CMOS sensor-based digital still camera systems, the situation is different. In order to eliminate the need of vertical charge coupled devices, each line is sent out for readout immediately after exposure. Therefore, a rolling exposure is devised, as shown in FIG. 12. When the first line is read out, the second line is sent out for reading immediately. As a result, the instance of end of exposure of each line is determined by the readout speed. However, in order for the entire array to have the same amount of exposure, the start of exposure of each line needs to be adjusted accordingly. The result is that different lines are exposed at different time spot.

In order to achieve the goal of taking exposure at the same instance for the entire array, prior arts modified the exposure mechanism as shown in FIG. 13. In this method, the entire array is reset and starts exposure at the same instance T0. However, the end of exposure of each line is still different. The system will rely on the closure of a mechanical shutter or light shielding means to end the exposure of the entire array at the same instance T1. In this way, the exposure amount of the entire array will be the same. The difficulty with this kind of mechanical shutter design is that the shortest exposure period is determined by the speed of the mechanical shutter, similar to interlaced transfer CCD. This makes the system design difficult to achieve short exposure period with low cost. Another disadvantage is that the DC offset level caused by dark current accumulation in the photodiode will be different for each individual line.

There are new CMOS sensor designs that implement frame exposure mechanism in addition to rolling exposure. In this frame exposure mode, the entire array is exposed at the same time, and the image charges are temporarily stored locally at each pixel. The image is later read out line by line. The purpose of this kind of design is to eliminate the need of mechanical shutter completely. However, during image readout, even though the exposure is already halted, there may still be some noises generated by the light. A great deal of semiconductor design effort is needed to overcome the associated smear problem, similar to that encountered by CCD. Therefore, it will be of great help to adopt a mechanical shutter to block the incident light during image readout.

Consequently, the purpose of the present invention is to provide an image pickup apparatus and an operating method therefor to solve the foregoing problems faced by the CMOS image sensors in the prior art.

### SUMMARY OF THE INVENTION

It is therefore an object of the present invention to provide an image pickup apparatus having simpler structure and an operating method to solve the foregoing problems, and at the same time, image pickup can be performed at a high shutter speed by use of a comparatively low speed mechanical shutter.

It is another object of the present invention to provide an image pickup apparatus to adopt simpler lens design to cover a wide exposure range.

In order to achieve the foregoing objectives, the present invention is directed to an image pickup apparatus in which a CMOS image sensor with an electronic shutter is used, and a mechanical shutter is provided in front of the CMOS image sensor.

According to an aspect of the present invention, at the beginning of the exposure period unnecessary charges accumulated on the CMOS image sensor are reset and discharged simultaneously, where the above-mentioned mechanical shutter is in the opened state before the start of exposure, image signals of the entire array are stored locally under the control of the exposure finish signal, next the mechanical shutter is closed and then the entire array is read out row by row after a short period of delay, so that an electronic shutter function is realized.

According to the image pickup apparatus including such a mechanism according to the present invention, the mechanical shutter is closed to photo-shield the entire CMOS image sensor perfectly after the exposure finish signal, where the signal charges in the entire photodiode elements of the CMOS image sensor being held at storage charge transfer lines thereof temporarily, so that it is possible to prevent smears from occurring during image readout. Moreover, since the electronic exposure is performed by the electronic shutter and later the mechanical shutter is closed for the purpose of photo-shield, the precision of the exposure period does not need to depend on the mechanical shutter, so that it is possible to obtain high precision of the exposure period by the electronic shutter. Further, since the mechanical shutter only has to be closed after a period of time after the exposure finish signal is set, it is possible to use a simple mechanical shutter with low-speed characteristic and low shutter delay precision.

According to another aspect of the present invention, the mechanical shutter can be located in front of the lens module in order to simplify the lens module design. The lens module can either contain a single aperture or multiple apertures. When multiple apertures are implemented, the apertures can be located in front of the mechanical shutter, between the mechanical shutter and the lens module, inside the lens module or between the lens module and the CMOS image sensor.

According to still another aspect of the present invention, the mechanical shutter can be located between the lens module and the CMOS image sensor in order to simplify the lens module design. The lens module can either contain a single aperture or multiple apertures. When multiple apertures are implemented, the apertures can be located in front of the lens module, inside the lens module, between the lens module and the mechanical shutter, or between the mechanical shutter and the CMOS image sensor.

According to still another aspect of the present invention, an auto-focus control mechanism can be designed so that the lens module can be controlled by a driving means to move along the optical axis. Since the mechanical shutter is located either in front of the lens module or between the lens module and the CMOS image sensor, the auto-focus control mechanism can be simplified.

According to still another aspect of the present invention, an auto-focus control mechanism can be designed so that the lens module can be controlled by a driving means to move along the optical axis. Since the apertures can also be located either in front of the lens module or between the lens module and the CMOS image sensor, the auto-focus control mechanism can be further simplified

According to still another aspect of the present invention, a zoom control mechanism can be designed so that the lens module or portions of the lens module can be controlled by a driving means to move along the optical axis. Since the mechanical shutter is located either in front of the lens module or between the lens module and the CMOS image sensor, the zoom control mechanism can be simplified.

According to still another aspect of the present invention, a zoom control mechanism can be designed so that the lens module or portions of the lens module can be controlled by a driving means to move along the optical axis. Since the apertures is located either in front of the lens module or between the lens module and the CMOS image sensor, the zoom control mechanism can be further simplified.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Other features and advantages of the present invention will be apparent from the following description taken in connection with the accompanying drawings which are given by way of illustration only, and thus are not limited to the present invention, and wherein:

FIG. 1 is a diagram illustrating the configuration of an image pickup apparatus of an embodiment in accordance with the present invention;

FIG. 2 is a diagram illustrating the timing sequence of the first preferred embodiment according to the present invention;

FIGS. 3a and 3b are diagrams respectively illustrating an operation sequence flow chart of an image pickup apparatus according to the present invention;

FIG. 4 is a diagram illustrating another operation sequence flow chart of an image pickup apparatus according to the present invention;

FIG. 5 is a diagram illustrating an image pickup operation sequence flow chart of the first preferred embodiment according to the present invention as in FIG. 2;

FIG. 6 is a diagram illustrating the timing sequence of the second preferred embodiment according to the present invention when the necessary exposure period is comparatively short;

FIG. 7 is a diagram illustrating an image pickup operation sequence flow chart of the second preferred embodiment in accordance with the present invention as in FIG. 6;

FIG. 8 is a diagram illustrating the timing sequence of the third preferred embodiment according to the present invention when the necessary exposure period is long;

FIG. 9 is a diagram illustrating an image pickup operation sequence flow chart of the third preferred embodiment in accordance with the present invention as in FIG. 8;

FIGS. 10a, b, c and d are sketch diagrams illustrating the structure of the image pickup apparatus, showing the arrangements of the lens module and the mechanical shutter in the preferred embodiments of the present invention;

FIG. 11 is a diagram illustrating the timing sequence of a conventional CCD image sensor-based image pickup system with mechanical shutter;

FIG. 12 is a diagram illustrating the timing sequence of a conventional CMOS image sensor-based image pickup system implemented with rolling exposure;

FIG. 13 is a diagram illustrating the timing sequence of another conventional CMOS image sensor-based image pickup system that relies on fast and precise control of the closure of mechanical shutter to achieve high shutter speed;

### DETAILED DESCRIPTION OF THE PREFERRED EMBODIMENT

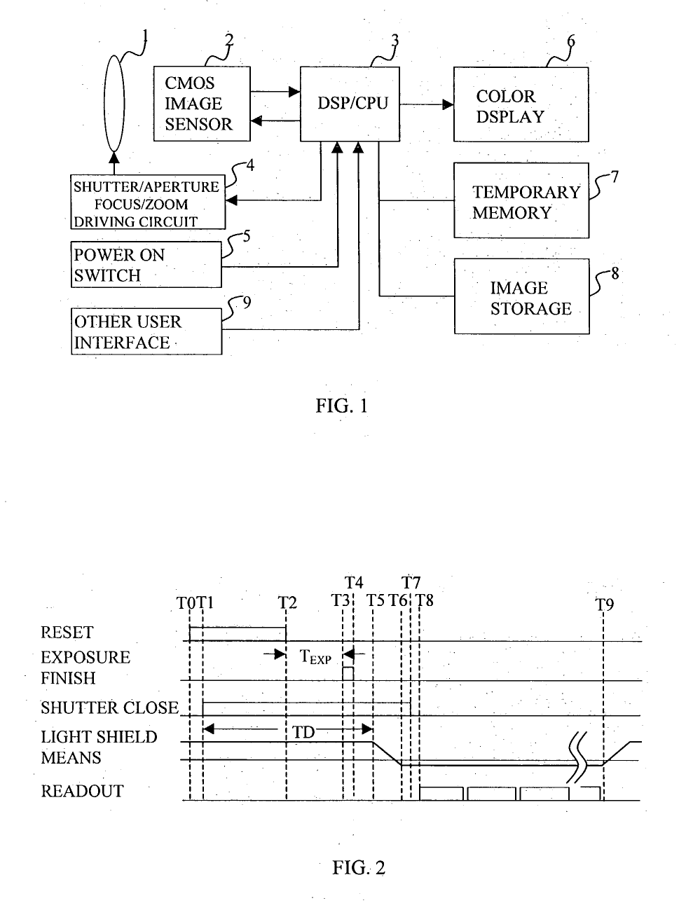

An embodiment of the present invention will be described with reference to FIG. 1. FIG. 1 shows the structure of a CMOS image sensor-based image pickup apparatus in an electronic still camera. As an image pickup device, a CMOS image sensor with a timing feature similar to that illustrated in FIG. 2 is utilized.

First, the structure will be described. In FIG. 1, the reference numeral 2 represents a CMOS image sensor, which can be a passive pixel sensor or an active pixel sensor, wherein the latter is a better option for enhancing signal to noise ratio and image quality. The CMOS image sensor 2 is used for generating image signals of an image, which has photodiode elements (so called pixels) and associated timing circuits and analog-to digital converters.

The reference numeral 1 represents a lens module, which may include an aperture, a mechanical shutter, an auto-focus and zoom control mechanism and can be controlled by a driving means to move along the optical axis, disposed in front of the CMOS image pickup device 2.

The reference numeral 3 represents a digital signal processing unit that controls the system control as well as image processing, compression, decompression, display and storage. The digital signal processing unit 3 can also include a timing control means used for generating timing signals for the CMOS image sensor. In practical applications, the timing means is generally integrated on the CMOS image sensor. The digital signal processing unit 3 is coupled to the CMOS image sensor 2, while the timing generating means thereof is operatively coupled to the the CMOS image sensor 2 for synchronizing operation thereof to sequentially transfer the image signal to the digital signal processing unit 3.

The reference numeral 6 represents an image display means, usually it is a color LCD display panel that can function as electronic viewfinder or image playback means. The image display means can also include TV display circuits.

The reference numeral 7 represents a temporary data storage memory, which can be used to store the program for the image pickup apparatus control, temporary image data during processing and compression/decompression and before sending to permanent storage memory. The reference numeral 8 represents a non-volatile storage memory unit, including integrated on-board memory and/or removable memory, which can be used to store the images captured and/or the program for the image pickup apparatus control.

The reference numeral 4 represents a lens driving means including mechanical shutter, aperture, focusing and zoom control. The mechanical shutter driving means includes a shutter driving circuit, which can include a solenoid or a stepping motor, possibly with other mechanical structure to actually drive the mechanical shutter. The timing sequence can be generated by a dedicated circuit, by the digital signal processing unit 3 or by a combination of both.

The reference numeral 5 represents a power on switch or equivalent mechanism for starting the image pickup apparatus operation. Upon receiving the power on signal, the digital signal processing unit 3 will prepare the image pickup apparatus in order to be ready for taking pictures. Depending on the system design architecture and the operating mode of the image pickup apparatus, the digital signal processing unit 3 will control the lens driving means 4 to open the mechanical shutter in order to enter the electronic viewfinder mode, or simply enters the ready-for-capture status.

The reference numeral 9 represents other user interface keys, buttons or other status display means, such as a shutter release button, LED, buzzer or speaker. The shutter release button is operatively coupled to the control means of the digital signal processing unit 3 for directing the control means to open the mechanical shutter of the CMOS image sensor 3 to expose the photodiode elements.

According to the present invention, the operating method for the image pickup apparatus comprises of the following steps: opening the mechanical shutter before taking a picture; and then activating the shutter release button to start timing sequence of first electronic shutter for controlling the beginning of exposure for the picture to be taken; after some delay which is calculated in advance, activating a mechanical shutter close control signal for closing the mechanical shutter in order to shield the CMOS image sensor from lighting; next activating a second electronic shutter to complete exposure for the picture to be taken; transferring image signals sequentially to readout portion of the CMOS image sensor after the mechanical shutter is completely closed.

Further, according to the present invention, another operating method for the image pickup apparatus comprises of the following steps: activating a shutter release button to open a mechanical shutter; and then clearing residual charges of the photodiode elements in order to start accumulation of image charges; and then immediately closing the mechanical shutter; after the mechanical shutter has been closed fully, transferring accumulated signal charges of the first field from the storage charge transfer lines to the horizontal charge transfer line and then read out them to output the time series picture element signals of the first field; subsequently transferring accumulated signal charges of the second field from the adjacent vertical charge transfer lines to the storage charge transfer lines then to the horizontal charge transfer line and then readout them to form the time series picture element signals.

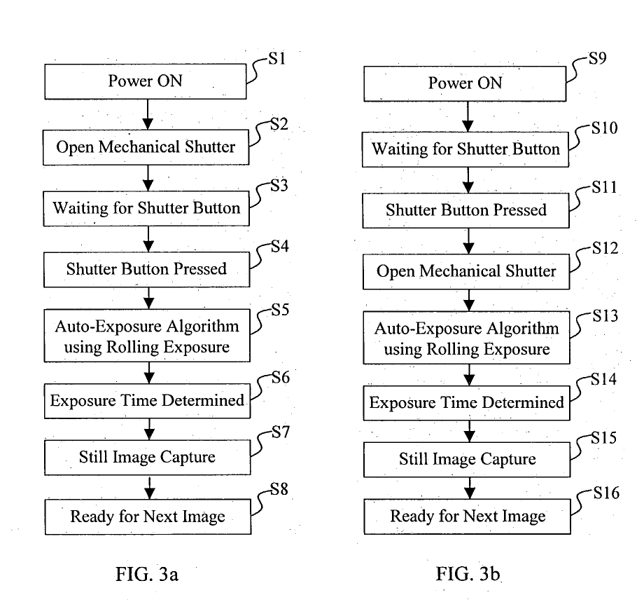

Next, the operation of the first embodiment having such a configuration will be described on the basis of a timing chart shown in FIG. 2. Two typical operation sequence flow charts are shown respectively in FIGS. 3a and 3b. For an image pickup apparatus, usually auto-exposure is adopted and exposure is determined automatically after the operator pressed the shutter release button. As in FIG. 3a, when the operator turns on the power of the image pickup apparatus at step S1, the image pickup apparatus will quickly start running the system firmware and get ready for image pickup operation. At step S2 the image pickup apparatus will open the mechanical shutter so that the camera can take an image immediately. The image pickup apparatus is then waiting for the operator to press the shutter release button to take an image, as shown by step S3. When the operator presses the shutter as in step S4, the image pickup apparatus will enter step S5 immediately. In step S5, the digital signal processing unit 3 will keep the mechanical shutter open and take a few sub-sampled images for analysis in order to determine the optimal exposure settings for the final still image at step S6. Step S7 is the actual image capture timing control sequence, which will be disclosed in detail in FIG. 5.

FIG. 3b shows a second embodiment of operation sequence flow chart of the image pickup apparatus. The operator turns on the power of the image pickup apparatus at step S1, the image pickup apparatus quickly starts running the system firmware and gets ready for camera operation. The image pickup apparatus waits for the operator to press the shutter release button at step S10 without opening the mechanical shutter in order not to allow the light to fall on the CMOS image sensor, thereby preventing the CMOS image sensor from being damaged accidentally by extremely strong incident light. When the operator pressed the shutter release button at step S11, the image pickup apparatus will then open the mechanical shutter at step S12. Only after the mechanical shutter is opened will the image pickup apparatus start auto-exposure algorithm as represented by step S13. Similar to FIG. 3a, the digital signal processing unit 3 will keep the mechanical shutter open and take a few sub-sampled images for analysis in order to determine the optimal exposure settings for the final still image at step S14. Step S15 is the actual image capture timing control sequence, which will be disclosed in detail in FIG. 5. The disadvantage of the control flow as in FIG. 3b is that it takes some time for the image pickup apparatus to open the mechanical shutter, such that the delay from the instant the operator presses the shutter release button to the final image that is actually captured is increased.

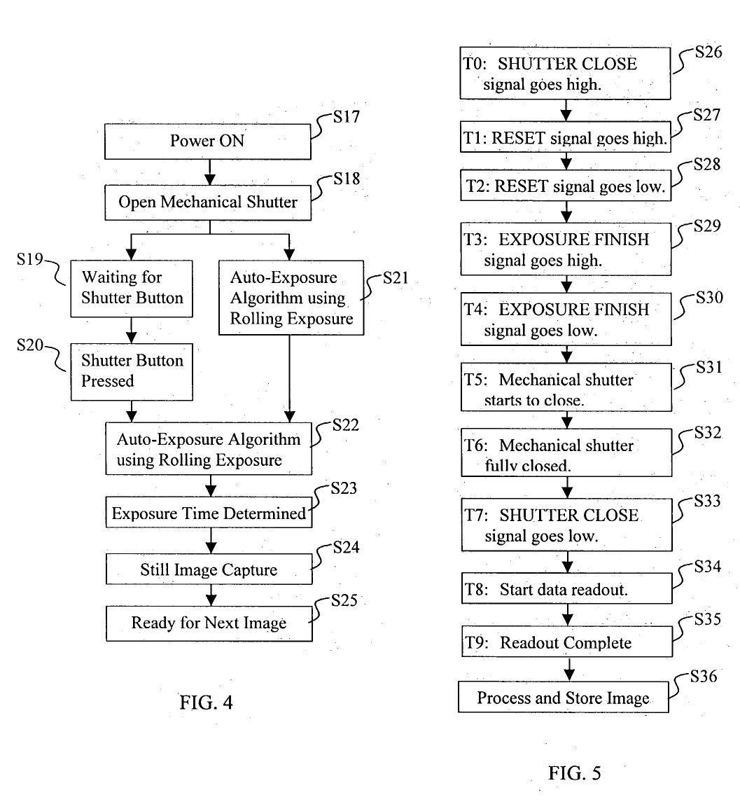

FIG. 4 shows a different embodiment of the operation sequence flow chart of the image pickup apparatus. When the operator turns on the power of the image pickup apparatus at step S17, the image pickup apparatus quickly starts running the system firmware and get ready for image pickup operation. At step S18 the mechanical shutter is opened so that the image pickup apparatus can take an image immediately. In order to reduce the delay time from the instant the operator presses the shutter release button to the final image that is actually captured, the image pickup apparatus starts auto-exposure algorithm with the rolling-exposure method once the mechanical shutter is opened. At the same time the image pickup apparatus is waiting for the operator to press the shutter release button, as represented by step S19. When the operator finally presses the shutter release button at step S20, the image pickup apparatus enters step 22 and performs the auto-exposure again. It is expected that in most cases, the procedure at step S21 already approaches the optimal exposure for the image pickup apparatus, such that the delay time can be reduced significantly.

Next, the timing sequence of the first embodiment of the present invention with timing sequence shown in FIG. 2 will be described in detail along with the flow chart of FIG. 5. It is assumed that a solenoid with two stable states, ON and OFF, is adopted. The solenoid can change state only when power is supplied and proper control signal is applied. The mechanical shutter is open in the ON state, which allows the light to pass through the lens and falls on the surface of the CMOS image sensor. The mechanical shutter is closed in the OFF state, which blocks the light so that there will not be any light to fall on the CMOS image sensor. It is assumed that the high state of the “SHUTTER CLOSE” signal means that the solenoid is being energized to close the mechanical shutter. When the accumulated energy is enough, the mechanical shutter will be closed and the drive signal “SHUTTER CLOSE” can then goes low after the mechanical shutter is actually closed. For a typical low cost solenoid commercially available, the required time to accumulate enough energy is from 3 ms to around 50 ms. Therefore, care should be taken in order to achieve precise timing for the shutter control.

At time T0, which is the reference time for the timing sequence, signal RESET for the CMOS is set high. During the period when RESET is high, each pixel of the entire array of the CMOS sensor will be reset, or cleared, so that the charges accumulated because of the light falling on the photo-diode will be cleared. At time T1, where the time difference between T1 and T0 is carefully calculated, the “SHUTTER CLOSE” signal goes high. After a time has lapsed till time T2, where the time difference between T2 and T0 is fixed and determined before the reference time T0, signal RESET goes low and the electronic exposure begins, while the image charges start to accumulate. Since the instant T2 is fixed relatively to T0, the electronic exposure period can easily be controlled by raising the “EXPOSURE FINISH” signal high at time T3 and later low at time T4. At T5 the mechanical shutter starts to close because the solenoid has already accumulated enough energy. The time delay between T1 and T5 is usually fixed and should be measured earlier. By adjusting the instant of T1 with respect to T0 it can be guaranteed that T5 is always later in time compared to T4. At time T6 the mechanical shutter is completely closed, and signal SHUTTER CLOSE goes low at time T7 after some delay to make sure the mechanical shutter is firmly closed. Then, at time T8 the CMOS image sensor can start to readout image signals. After all image data are read out to CPU 3, the mechanical shutter can start to open again at time T9, of which the control signal is not shown.

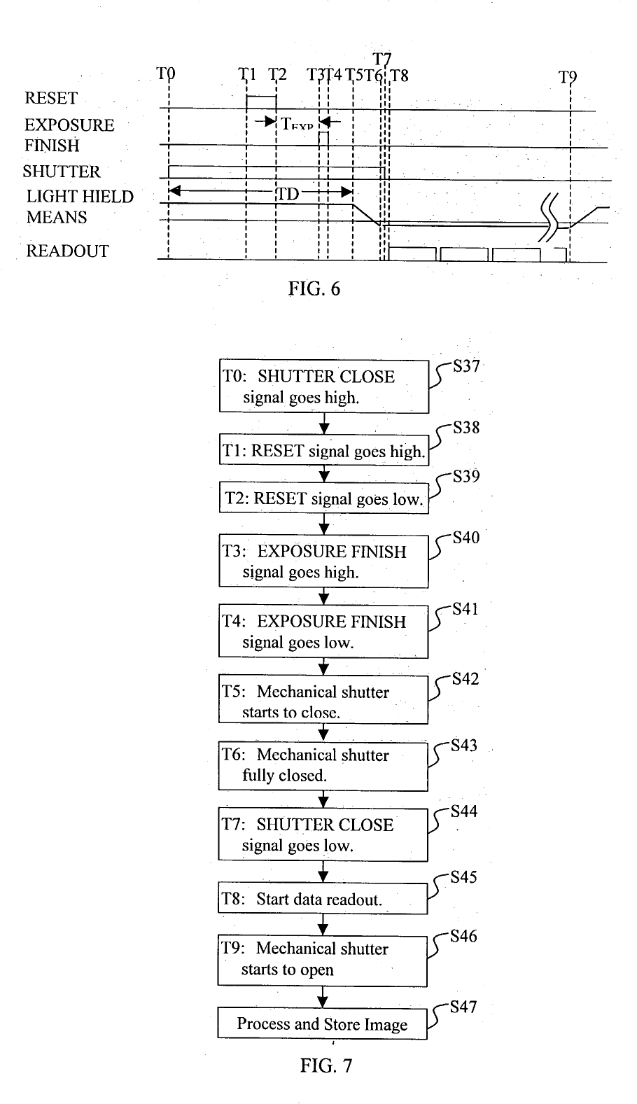

Next, the timing sequence of the second embodiment of the present invention with timing chart shown in FIG. 6 will be described in detail along with the flow chart of FIG. 7 when the necessary exposure period is comparatively short. Similar to the first embodiment, such the assumptions have been made.

Referring to FIGS. 6 and 7, firstly at time T0 regarded as the reference time for the timing sequence, the “SHUTTER CLOSE” signal goes high at step S37. Then at time T1, where the time difference between T1 and T0 is calculated in advance, signal RESET for the CMOS goes high at step S38. During the period when RESET is high, each pixel of the entire array of the CMOS sensor will be reset or cleared so that the charges accumulated because of the light falling on the photodiode will be cleared. After a time has elapsed till time T2, where the time difference between T2 and T1 is fixed and predetermined, signal RESET goes low at step S39 and synchronously the electronic exposure begins while the image charge start to accumulate. Since the instant T2 is fixed relatively to T1, the electronic exposure period can easily be controlled with the EXPOSURE FINISH signal being set high at time T3 at step S40 and later low at time T4 at step S41. At time T5, the mechanical shutter starts to close at step S42 because the solenoid has already accumulated enough energy. The time delay between T0 and T5 is usually fixed and should be measured earlier. After a time has elapsed till time T6, the mechanical shutter is fully closed at step S43, and at time T7 signal SHUTTER CLOSE goes low at step S44 after some delay to make sure the mechanical shutter is firmly closed. Then, at time T8 the CMOS image sensor can start to readout image signals at step S45. After all image data are read out to CPU 3, the mechanical shutter can start to open again at time T9 in step S46. And then the image data pickup procedure has been accomplished and all image data acquired begin to be processed and stored at step S47. In this way, the exposure control for the image pickup apparatus of this embodiment according to the present invention has been achieved perfectly in the case of comparatively short exposure period required.

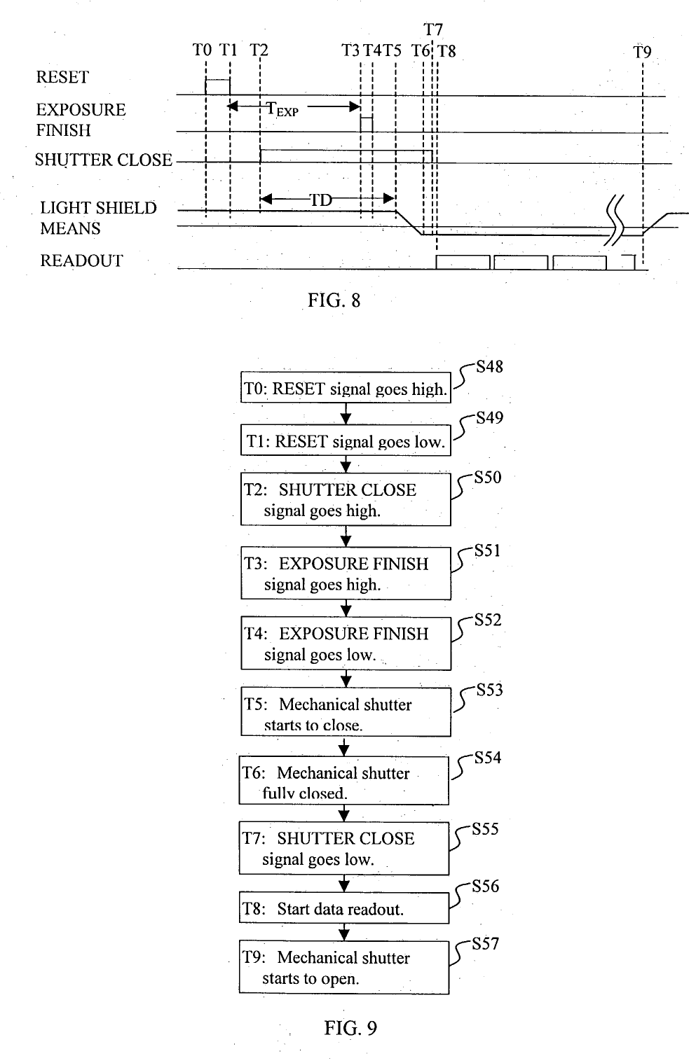

Further, the timing sequence of the third embodiment of the present invention with timing chart shown in FIG. 8 will be described in detail along with the flow chart of FIG. 9 when the necessary exposure period is long. Similar to the above two embodiment, such the assumptions also have been made.

Referring to FIG. 8 and 9, at time T0 regarded as the reference time for the timing sequence, signal RESET for the CMOS goes high at step S48 at first. During the period when RESET is high, each pixel of the entire array of the CMOS sensor will be reset or cleared so that the charges accumulated because of the light falling on the photodiode will be cleared. After a time has elapsed till time T1, where the time difference between T0 and T1 is fixed and predetermined, signal RESET goes low at step S49 and at the same time the electronic exposure begins while the image charge start to accumulate. After a time has elapsed till T2, where the time difference between T1 and T2 is calculated in advance, the “SHUTTER CLOSE” signal goes high at step S50. Then, the electronic exposure is finished by the way of the EXPOSURE FINISH signal being set high at time T3 at step S51 and later low at time T4 at step S52. Similar to the next timing sequence and the corresponding flow chart of the second embodiment as shown in FIG. 6 and 7, the mechanical shutter starts to close at time T5 at step S53 because the solenoid has already accumulated enough energy. The time delay between T2 and T5 is usually fixed and should be measured earlier. After a time has elapsed till time T6, the mechanical shutter is fully closed at step S54, and at time T7 signal SHUTTER CLOSE goes low at step S55 after some delay to make sure the mechanical shutter is firmly closed. Then at time T8, the CMOS image sensor can start to readout image signals at step S56. After all image data are read out to CPU 3, the mechanical shutter can start to open again at time T9 in step S57. Thus, the image data pickup procedure has been finished entirely.

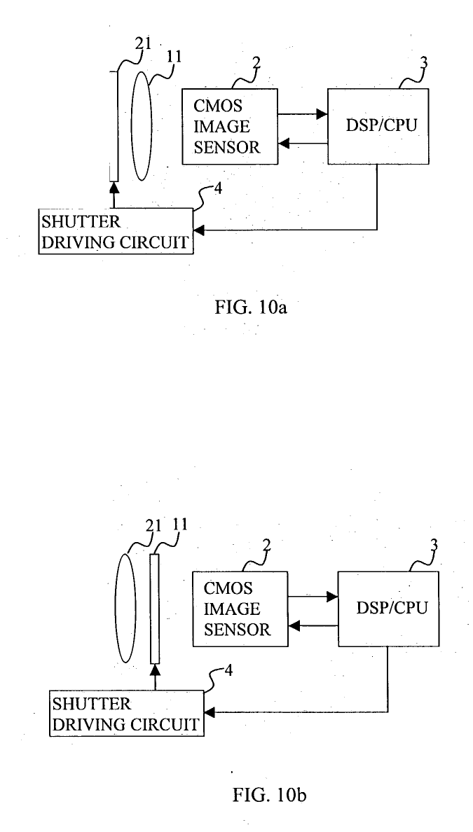

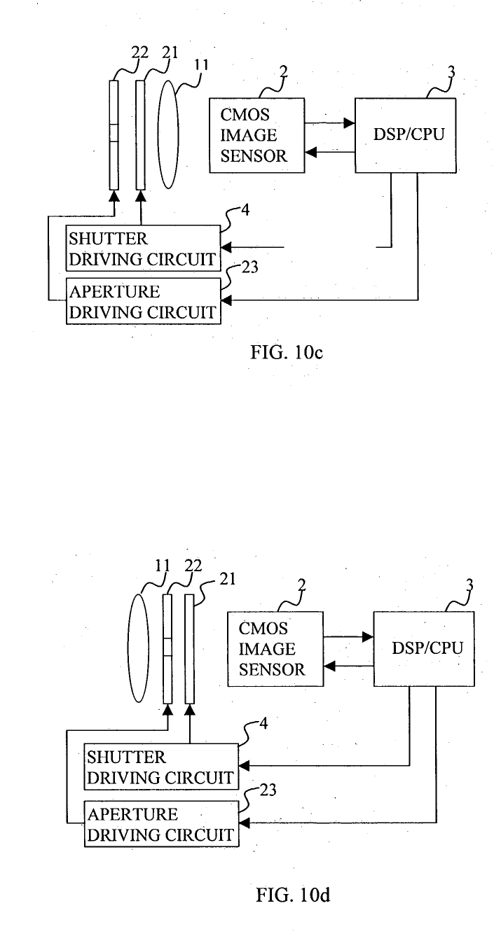

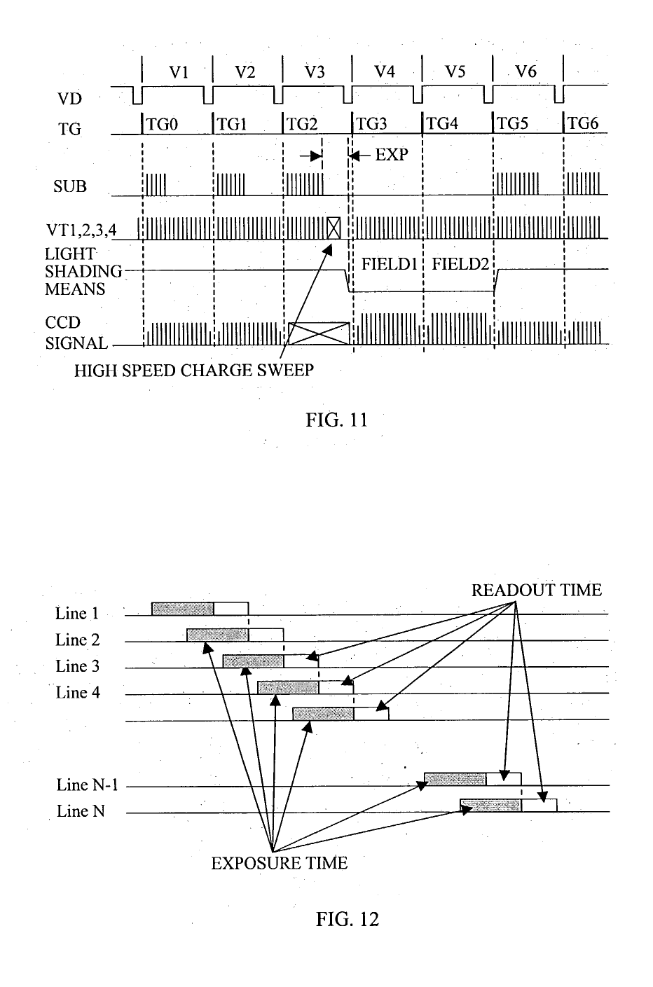

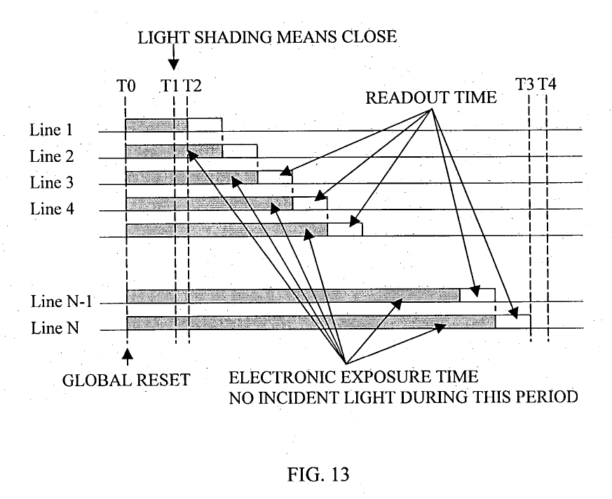

Moreover, the image pickup apparatus in accordance with the present invention can enable the lens module design thereof simplified by employing various arrangements of the mechanical shutter. For instance, the mechanical shutter can be located in front of the lens module or between the lens module and the CMOS image sensor to simplify the lens module and the auto-focus and zoom control mechanism of the lens module. Further, the lens module can either contain a single aperture or multiple apertures. Thus, when the mechanical shutter is located in front of the lens module and a single aperture is implemented, the aperture can be located in front of the mechanical shutter, between the mechanical shutter and the lens module, inside the lens module or between the lens module and the CMOS image sensor. When the mechanical shutter is located between the lens module and the CMOS image sensor and a single aperture is implemented, the aperture can be located in front of the lens module, inside the lens module, between the lens module and the mechanical shutter, or between the mechanical shutter and the CMOS image sensor. Namely, FIG. 10a, b, c and d show four image pickup apparatus embodiments with different arrangement of the mechanical shutter therein, wherein the lens module is represented by number 11, the mechanical shutter is represented by number 21 which is controlled by the shutter driving circuit 4 and the digital signal processing unit 3, the CMOS image sensor is represented by number 2, the aperture is represented by number 22 which is controlled by the aperture driving circuit 23 and the digital signal processing unit 3.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An operating method for an image pickup apparatus comprising the following steps:
opening a mechanical shutter before taking a picture;
activating a shutter release button to start timing sequence of first electronic shutter for controlling the beginning of exposure for the picture to be taken;
next activating a mechanical shutter close control signal to close said mechanical shutter in order to shield image sensor from lighting;
next finishing the first electronic shutter control signal so that the exposure starts;
activating a second electronic shutter to complete exposure for the picture to be taken before the mechanical shutter actually closed;
transferring image signals sequentially to readout portion of said image sensor after said mechanical shutter is completely closed;

2. An operating method for an image pickup apparatus comprising the following steps:
opening a mechanical shutter before taking a picture;
activating a shutter release button to start timing sequence of exposure control;
activating a mechanical shutter close control signal to close said mechanical shutter in order to shield image sensor from lighting;
activating and completing first electronic shutter for controlling the beginning of exposure for the picture to be taken after the mechanical shutter close control signal is started;
activating a second electronic shutter to complete exposure for the picture to be taken before the mechanical shutter actually closed;
transferring image signals sequentially to readout portion of said image sensor after said mechanical shutter is completely closed;

3. An operating method for an image pickup apparatus comprising the following steps:
opening a mechanical shutter before taking a picture;
activating a shutter release button to start timing sequence of first electronic shutter for controlling the beginning of exposure for the picture to be taken;
after the first electronic shutter control signal is completed, activating a mechanical shutter close control signal to close said mechanical shutter in order to shield image sensor from lighting;
next activating a second electronic shutter to complete exposure for the picture to be taken before the mechanical shutter actually closed;
transferring image signals sequentially to readout portion of said image sensor after said mechanical shutter is completely closed;

4. An image pickup apparatus comprising:
A CMOS image sensor as image pickup device, having a electronic shutter mechanism that can provide exposure of the entire array at the same instant;
A lens module coupled to said CMOS image sensor, with the lens positioned between mechanical shutter mechanism and the CMOS sensor;
A control means for responding to a shutter release signal from the user and controlling the electronic shutter and mechanical shutter to achieve proper exposure according to the method as in claim 1 and sending the image signals to the image processing means for processing;
shutter release means, operatively coupled to said control means, for directing said control means to open a shutter means to expose said photodiode elements;

5. An image pickup apparatus comprising:
A CMOS image sensor as image pickup device, having a electronic shutter mechanism that can provide exposure of the entire array at the same instant;
A lens module coupled to said CMOS image sensor, with mechanical shutter mechanism positioned between the lens and the CMOS sensor;
A control means for responding to a shutter release signal from the user and controlling the electronic shutter and mechanical shutter to achieve proper exposure according to the method as in claim 1 and sending the image signals to the image processing means for processing;
shutter release means, operatively coupled to said control means, for directing said control means to open a shutter means to expose said photodiode elements.

6. An image pickup apparatus comprising:
A CMOS image sensor as image pickup device, having a electronic shutter mechanism that can provide exposure of the entire array at the same instant;
A lens module coupled to said CMOS image sensor, with the lens positioned between mechanical shutter mechanism and the CMOS sensor;
A control means for responding to a shutter release signal from the user and controlling the electronic shutter and mechanical shutter to achieve proper exposure according to the method as in claim 2 and sending the image signals to the image processing means for processing;
shutter release means, operatively coupled to said control means, for directing said control means to open a shutter means to expose said photodiode elements;

7. An image pickup apparatus comprising:
A CMOS image sensor as image pickup device, having a electronic shutter mechanism that can provide exposure of the entire array at the same instant;
A lens module coupled to said CMOS image sensor, with mechanical shutter mechanism positioned between the lens and the CMOS sensor;
A control means for responding to a shutter release signal from the user and controlling the electronic shutter and mechanical shutter to achieve proper exposure according to the method as in claim 2 and sending the image signals to the image processing means for processing;
shutter release means, operatively coupled to said control means, for directing said control means to open a shutter means to expose said photodiode elements.

8. An image pickup apparatus comprising:
A CMOS image sensor as image pickup device, having a electronic shutter mechanism that can provide exposure of the entire array at the same instant;
A lens module coupled to said CMOS image sensor, with the lens positioned between mechanical shutter mechanism and the CMOS sensor;
A control means for responding to a shutter release signal from the user and controlling the electronic shutter and mechanical shutter to achieve proper exposure according to the method as in claim 3 and sending the image signals to the image processing means for processing; and
shutter release means, operatively coupled to said control means, for directing said control means to open a shutter means to expose said photodiode elements.

9. An image pickup apparatus comprising:
A CMOS image sensor as image pickup device, having a electronic shutter mechanism that can provide exposure of the entire array at the same instant;
A lens module coupled to said CMOS image sensor, with mechanical shutter mechanism positioned between the lens and the CMOS sensor;
A control means for responding to a shutter release signal from the user and controlling the electronic shutter and mechanical shutter to achieve proper exposure according to the method as in claim 3 and sending the image signals to the image processing means for processing; and
shutter release means, operatively coupled to said control means, for directing said control means to open a shutter means to expose said photodiode elements.
